(19) United States
(12) Patent Application Publication
(10) Pub. No.: US 2014/0158158 A1
(43) Pub. Date: Jun. 12, 2014

(54) BURLED GRINDING AND CLEANING FLEECE

(71) Applicant: JÖST GmbH, Wald-Michelbach (DE)

(72) Inventors: Peter Jöst, Abtsteinach (DE); Christian Jöst, Abtsteinach (DE)

(73) Assignee: JÖST GmbH, Wald-Michelbach (DE)

(21) Appl. No.: 14/097,820

(22) Filed: Dec. 5, 2013

(30) Foreign Application Priority Data
Dec. 12, 2012 (DE) 102012222886.1

(51) Int. Cl. A47L 11/40; B29C 43/00

(52) U.S. Cl. CPC A47L 11/4038; B29C 43/003
USPC 134/6; 15/209.1; 264/136; 264/324

(57) ABSTRACT

A grinding and cleaning fleece 1, for the machine-based grinding and machine-based cleaning of structured surfaces, consists of a fleece body 10, which includes a processing surface 11 with a plurality of burls 14. A method of manufacturing and use of the cleaning fleece is also disclosed.

### FIELD OF THE INVENTION

The invention relates to a burled grinding and cleaning fleece, for the machine-based treatment of structured surfaces, and in particular of structured floorings. In particular, such a grinding and cleaning fleece may be used for the cleaning of polymer-floorings with structured surfaces that are difficult to care for.

### PRIOR ART

Floorings with structured surfaces are used in many fields, in particular in the health sector, in industry and in business, in airports, in bureau- and administration-buildings as well as in residential buildings. In addition to floorings with a plane surface, also floorings with a distinctive surface structure are available. By this surface structure the floorings appear to be more natural and reduces the risk of slipping. For instance, polymer-floorings with a shale structure, a wood-structure, a hammered structure or with round burls are known. The structuring may comprise a height of some millimeters.

An intensive cleaning of such floorings is a huge problem, which has not been optimally solved yet. Known cleaning products and-systems, like for instance brushing machines with brush-drums or single-disc-machines, trio-machines or cleaning automates, which use plain cleaning pads, do not reach deeper areas of the profiled surface so that an intensive cleaning of the entire surface is not possible. In particular, dirt from deeper areas of the profiled surface cannot be removed, since the cleaning means only reach the protruding areas of the structured surface of the flooring. Soft brush drums indeed reach the deeper areas of the surface structure of the floor, but their cleaning effect is very low.

Furthermore, pot- and dish-cleaning sponges are known, which comprise a resilient profiled surface. These pot- and dish-cleaning sponges are used for the dish cleaning by hand and are not appropriate for the machine-based floor cleaning by principle.

Furthermore, polishing-sponges with a resilient profiled surface are known, which are used in combination with liquid polishing means for the polishing of car-lacquer-surfaces. However, these polishing-sponges are not allowed to comprise any cleaning or grinding-effect by itself, in order to avoid a damaging of the lacquer surface.

Furthermore, plain fleece-cleaning discs and “Floor Pads”, respectively, are known, which are used together with the above mentioned single-disc- and trio-machines for the treatment of floorings. In general, they comprise are circularly shaped and are available in many different embodiments depending on the application, for instance for polishing-, cleaning, scrubbing-, dust-removing-, dirty-water-reception-, or floor-finishing-applications. However, these plain fleece-cleaning discs are only appropriate for the treatment of even floors, since they are also not able to enter into the deeper areas of structured floorings due to their plain surface. In consequence, only the protruding areas of structured floorings are cleaned by such fleece-cleaning discs, while the dirt remains in the deeper areas.

From the EP 2 353 484 B1 of the same applicant, grinding and cleaning bodies are known, which comprise a profiled base body made of a foamed polymer material onto which a processing layer made of synthetic resin is applied. Indeed, these grinding and cleaning bodies are in general appropriate for the cleaning of structured surfaces. However their lifetime is comparatively short, in particular, if cleaning agents with a high concentration of solvents are used. These cleaning agents may be such aggressive that they detach the binding resins by which the abrasive particles are attached to the foamed material or even the foamed material of the grinding and cleaning body itself.

Thus, the present invention solves the problem to provide a grinding and cleaning body for the effective machine-based cleaning of structured surfaces, in particular floorings.

### SUMMARY OF THE INVENTION

The above mentioned problem is solved by a grinding and cleaning fleece according to patent claim 1, a method for the manufacturing of a grinding and cleaning fleece according to patent claim 14 as well as by a method for the use of a grinding and cleaning fleece according to patent claim 17.

In particular, the problem is solved by a grinding and cleaning fleece for the machine-based grinding and machine-based cleaning of structured surfaces, comprising a fleece body, which comprises a processing surface with a plurality of burls.

Due to the fact that the fleece body comprises a processing surface with a plurality of burls, the processing surface, which is provided for the cleaning, may also reach well deeper areas of the structured surface, like for instance of a flooring. During the grinding or cleaning, the burls of the resilient fleece body are pressed into the deeper areas of the surface structure of the flooring, such that the burls do also clean or grind these deeper areas at their basis. By doing so, also highly structured floors, like for instance, burled polymer-floors may be cleaned completely, which is not possible by the use of usual plain floor pads.

Since grinding and cleaning fleeces according to the invention are made of robust fleece material, they comprise a lifetime, which corresponds to common floor pads. The grinding and cleaning fleeces according to the invention can be adapted by their fiber-fleece-structure, fiber-thickness, grinding-particle-size, or binding-resin as well as by thickness and shape of the burls to the specific requirements.

Preferably, the burls of the burled processing surface are integral elements of the fleece body. The burls are directly formed out of the fleece body. That means that the burls are not attached or glued in any manner, but consist directly of the fleece body itself. Here it is ensured that the burls may not detach from the fleece body. The use of adhesives for the fixation of the burls may be omitted herewith, which both saves costs for the manufacturing and is friendly to the environment. The integral design of the burls in the fleece body also increases the lifetime of the grinding and cleaning fleece, since now also aggressive cleaning means are not able to detach or to destroy the burls.

Preferably, the burls of the burled processing surface comprise a lower density compared to the other regions of the fleece body. Due to the lower density of the burls it is achieved that the burls are resilient and can adapt themselves to the structured surface to be processed optimally. Thus, protrusions of the structured surface are also intensively processed like its valleys, what generates a homogeneous grinding and/or cleaning view on the surface to be treated.

Preferably, the fleece body comprises a plain fixation surface, which is arranged opposite to the burled processing surface. By this plain fixation surface, the grinding and cleaning body can be connected in a large area with a grinding and/or cleaning machine. By this connection the rotary or oscillatory movements of the cleaning or grinding-machines is transmitted to the grinding and cleaning fleece without any slipping.

Preferably, the burled processing surface of the grinding and cleaning fleece comprises abrasive particles, which are attached to the processing surface of the grinding and cleaning fleece by means of a binding resin. For the increase of the grinding and cleaning effect abrasive particles can be also glued to the processing surface. By the choice of the abrasive particle material and the abrasive particle size, the grinding and cleaning fleece can be adapted to a variety of different grinding or cleaning tasks. This allows the user to choose exactly this grinding and cleaning fleece from a wide product portfolio, which is optimally adapted to the specific circumstances of the respective grinding and cleaning task.

By an appropriate binding resin, like for instance polyurethane- or latex-based binding resins, it is possible to connect the abrasive particles to the processing surface of the fleece body such that the abrasive particles also remain during the contact with aggressive cleaning means at the processing surface and do not detach. Thus, the lifetime of the grinding and cleaning fleece is significantly raised and the grinding and cleaning result is improved. Furthermore, the binding resin can be chosen such that the fleece body becomes comparably stiff or resilient, in order to adapt itself to the surface structures in a better manner

Preferably, the grinding and cleaning fleece exclusively consists of the fleece body. In a further embodiment, the grinding and cleaning fleece consists of the fleece body and a hook-an-loop-adaption layer, wherein the hook-and-loop-adaption layer is arranged at the fixation surface of the fleece body. In a further embodiment, the grinding and cleaning fleece consists of the fleece body and a foam body, wherein the foam body is arranged at the fixation surface of the fleece body. In a further embodiment, the grinding and cleaning fleece consists of the fleece body, a foam body and a hook-and-loop adaption layer, wherein the foam body is arranged at the fixation surface of the fleece body and wherein the hook-and-loop adaption layer is arranged at a surface of the foam body, which is opposed to the surface of the foam body, at which the fleece body is arranged. In a further embodiment, the grinding and cleaning fleece consists of the fleece body, a foam body and a second fleece body, wherein the foam body is arranged at the fixation surface of the fleece body and wherein the second fleece body is arranged at a surface of the foam body, which is opposed to the surface of the foam body, at which the fleece body is arranged. In the case that the grinding and cleaning fleece exclusively consists of the fleece body, it does not comprise any further layers. Then, the connection between the grinding and cleaning fleece with the grinding and/or cleaning machine is generated preferably by means of friction, in that for instance the brush plate of a disc-floor cleaning machine is put onto the fleece body. In the other case, that the grinding and cleaning fleece consists of the fleece body and a hook-and-loop-adaption layer, the grinding and cleaning fleece can be attached easily and reliably by a hook-and-loop layer onto the plate of a grinding and/or cleaning machine. Thus, also vertical, structured surfaces can be processed.

In the case that the grinding and cleaning fleece consists of the fleece body and a foam body, the grinding and cleaning fleece can be adapted by the height of the foam body and/or the rigidity of the foam body and/or the material of the foam body to the grinding and/or cleaning task to be solved. This is advantageous in that material requirements concerning rigidity on the one hand and resilience on the other hand, which are intrinsically contradictory, are decoupled. The rigidity of the grinding and cleaning fleece, which is responsible for a sufficient grinding and/or cleaning effect and for a long lifetime, is in general determined by the fleece body while the resilience, which is responsible for the intensive cleaning also of the deeper areas of a flooring, is in general determined by the foam body. This gives further options for the choice of the material for the grinding and cleaning fleece. These options lead by the choice of cheaper materials to reduced production costs and/or allow adapting the grinding and cleaning fleece in an even better manner to the grinding and/or cleaning tasks to be solved. Further the lifetime of the grinding and cleaning fleece is increased since due to the foam body the pressure onto the fleece body is distributed and thus the burls stay longer in shape.

Furthermore, the grinding and cleaning fleece consists in a preferred embodiment of the fleece body, the foam body and a hook-and-loop adaption layer. As already mentioned above, the grinding and cleaning fleece can be easily and reliably attached by the hook-and-loop layer onto the plate of a grinding and/or cleaning machine. Thus, also vertical, structured surfaces can be processed.

In a further preferred embodiment, the grinding and cleaning fleece consists of the fleece body, the foam body and a second fleece body. The second fleece body preferably comprises a processing surface with a plurality of burls. The fleece body and the second fleece body comprise in a preferred embodiment, the same cleaning properties. This is advantageous since the lifetime of the grinding and cleaning fleece, which is already significantly increased, is doubled. When the fleece body reaches the end of its lifetime, the grinding and cleaning fleece has only to be turned around in order to go on with the cleaning by the use of the second fleece body. An exchange of the grinding and cleaning fleece is just necessary, when also the second fleece body has reached the end of its lifetime. Thus, the stock keeping of replacement-grinding and -cleaning fleeces is reduced and the handling of the grinding and cleaning machines is improved.

In an alternative embodiment, the fleece body and the second fleece body comprise different cleaning properties. This embodiment is in particular preferred, when in one single cleaning task different surfaces shall be processed or when the surface to be treated is dirty in a varying degree. Different surfaces lead to different grinding and/or cleaning tasks. According to this embodiment it is now possible for the first time just to turn around the grinding and cleaning fleece in a simple manner in order to solve different grinding or cleaning tasks. This safes significant changeover times and material costs.

Preferably, the burls comprise a height of 25% to 75%, preferably of 40% to 60% and most preferably of 50% of the total height of the fleece body, wherein the total height is measured from the fixation surface of the fleece body to the highest point of a burl. The height of the burls is a further parameter by which the grinding and cleaning effect can be adapted to surfaces to be processed, which comprise a different degree of profiling. Tests have shown that burls, which comprise a height of 25% to 75% of the total height of the fleece body, achieve a good processing result for the very most use cases. For many applications, the cleaning effect is optimal, when the burls comprise a height of about 50% of the total height of the fleece body. These dimensions achieve a good ratio between the flexibility of the burls and the stiffness necessary for the cleaning effect.

Preferably, the burls comprise at their base a maximum width of 3 mm to 30 mm, preferably a maximum width of 10 mm to 15 mm. By the width of the burls, the grinding and cleaning fleece can be also adapted to the specific cleaning task. Some large burls are more appropriate for surface structures with a roughly structured surface, like for instance a burled floor with round burls, which comprise a large base area. Contrary to that, a grinding and cleaning fleece with many small burls is preferably used for more fine structured surfaces.

In a preferred embodiment, burls of the processing surface comprise as base shapes circles and/or polygons and/or ellipse-like geometries. Also the base shape of the burls can vary. Herein it is preferred for manufacturing aspects to choose a round base shape. However, for other processing tasks, also other geometries like polygons or ellipse-like geometries can be used.

Also grinding and cleaning bodies are possible, wherein the processing surface is separated in different zones which are each exclusively provided with burls of one single base shape. In a further embodiment, burls with different base shapes can be arranged homogenously over the processing surface. Thus, it is possible to adapt the grinding and cleaning fleece in a further aspect to the specific cleaning task.

Preferably, the fleece body comprises a grammage of 120 g/m² to 2.000 g/m², preferably a grammage of 500 g/m² to 1.600 g/m². Thus, on the one hand the fleece body is stiff enough and on the other hand resilient enough so that the burls are pressed into the deeper areas of the surface to be processed, in order to achieve a good cleaning performance there.

Preferably, the grinding and cleaning fleece consists of polyester- or polyamide-based fibers, which comprise a thickness 1 to 400 dtex, preferably of 27 to 60 dtex. Polyester- or polyamide-based fibers are characterized in particular in that they are highly resilient if they get in contact with aggressive media like solvents in cleaning agents. Thus, the lifetime of the grinding and cleaning fleece is significantly increased. The stiffness of the grinding and cleaning fleece and in particular of the burls are defined by the thickness of the fibers. Thicker fibers are appropriate for rougher cleaning tasks and abrasive particles with larger diameters. By a fiber thickness in the range of 1 dtex to 400 dtex, preferably of 27 dtex to 60 dtex, grinding and cleaning fleeces can be adapted in an appropriate manner to the requirements of the grinding and/or cleaning task.

Preferably, the fleece body comprises a total height of 4 mm to 30 mm, preferably a total height of 8 mm to 20 mm and more preferably a total height of 10 mm to 15 mm. The total height of the fleece body is in particular relevant in view of the desired resilience and for the height of the burls of the grinding and cleaning fleece. For a total height of the fleece body in the range of 5 mm to 30 mm, the grinding and cleaning fleeces can be adapted in an appropriate manner to the requirements of the grinding and/or cleaning task.

Preferably, the fleece body comprises a round disc-shape with a diameter of 200 mm to 800 mm. Thereby, the grinding and cleaning fleece is in particular appropriate for the use in combination with a disc floor cleaning machine. For the use with an orbital sander, the fleece body can alternatively comprise a rectangular cut, comprising a width of 115 mm to 230 mm and a length of 200 mm to 500 mm.

The above-mentioned problem is also solved by a method for the manufacturing of a grinding and cleaning fleece for the machine-based grinding and machine-based cleaning, comprising a burled processing surface, wherein the method comprises the following steps:

a. inserting of a fleece web or of a fleece body into a press, wherein a first plate of the press is plane and wherein a counter-plate of the press comprises a perforated metal plate;
b. moving the plates towards each other with a pressure of 50 bar to 200 bar and a temperature of 50° C. to 200° C.;
c. maintaining of the pressure; and
d. removing of the fleece web or of the fleece body, which comprises a burled processing surface.

The method according to the invention for the manufacturing of the grinding and cleaning fleece is particularly efficient. Since the burls are formed from the fleece body and the fleece web, respectively, complex, cost-intensive manufacturing steps that moreover pollute the environment, like for instance an application of separate burls by the means of an adhesive layer are omitted. By the present manufacturing method, the deformation properties of fleece materials are used, which can be plastically formed by the use of pressure and heat and which maintain the new shape, when the pressure and the heat fall away.

Preferably, the method comprises the step of cutting or blanking of a fleece body out of the fleece web, if in step a. a fleece web was used. This way of manufacturing has the advantage that in one single press-step a large area of burled fleece web can be manufactured, which can be separated in the following into separate grinding and cleaning fleeces. Out of the fleece web the final shape of a finished grinding and cleaning fleece is cut or blanked after the manufacturing of the burled processing surface. Thus, the pressing step can be carried out in a most effective manner

Preferably, the method comprises furthermore the steps of:

f. applying a binding resin onto the fleece body or onto the fleece web prior to the insertion of the fleece web or of the fleece body into the press; and
g. applying abrasive particles onto the binding resin.

Abrasive particles are applied, if a high material removal shall be achieved like for instance for grinding processes. Preferably, polyurethane, latex or an acryl-based dispersion is used as a binding resin, since such resin systems are in particular appropriate to withstand aggressive cleaning agents and thus, the lifetime is significantly increased in comparison to other kinds of binding resins. Silicate and/or aluminum oxide and/or silicon carbide and/or zirconium and/or ceramics and/or diamond are preferably used as abrasive particles. The selection is done in view of the specific grinding and/or cleaning task in order to adapt the grinding and cleaning fleece optimally. Preferably, the binding resin and the abrasive particles are attached before the pressing of the fleece web or of the fleece body, so that the burls are not affected by thermal treatment during the curing of the binding resin.

The above-mentioned problem is also solved by the use of an above-mentioned grinding and cleaning fleece for the machine-based grinding and machine-based cleaning of structured floorings with a disc floor cleaning machine. By means of the above-described grinding and cleaning fleeces, now, for the first time deeper areas of a structured flooring can be reached. Thus, such floorings can be cleaned by a disc floor cleaning machine in a machine-based manner, wherein the burled processing surface of the cleaning body can enter the deeper areas of the structured surface of the flooring and can also process the valleys. By the fleece material used, furthermore a lifetime of the grinding and cleaning fleece is achieved, which is highly increased in view of the prior art.

Preferably, the grinding and cleaning fleece is connected with the disc floor cleaning machine by

a. mere putting the disc floor cleaning machine onto the grinding and cleaning fleece; or
b. attaching the grinding and cleaning fleece at the disc floor cleaning machine by means of a hook-and-loop adaption layer.

For the case that the grinding and cleaning fleece is connected by the mere putting of the disc floor cleaning machine onto the grinding and cleaning fleece, the connection is generated by friction, in particular by the weight of the disc floor cleaning machine. For the other case that the grinding and cleaning fleece is connected by an attachment of the grinding and cleaning fleece at the disc floor cleaning machine by means of a hook-and-loop adaption layer, the grinding and cleaning fleece can be easily and reliably attached at the grinding and/or cleaning machine. Thus, also a machine-based processing of vertical, structured surfaces is possible.

Further preferred embodiments result from the sub-claims.

### SHORT DESCRIPTION OF THE DRAWINGS

In the following, preferred embodiments of the present invention are described by means of the accompanying figures. In which shows:

FIG. 1 a grinding and cleaning fleece according to the invention with circularly shaped burls in a top view;

FIG. 2 the grinding and cleaning fleece of FIG. 1 in a sectional view along the section line s-s as well as an enlarged detail thereof;

FIG. 3 the grinding and cleaning fleece of FIG. 1 in a further embodiment, wherein the grinding and cleaning fleece comprises a hook-and-loop adaption layer in a sectional view along the section line s-s as well as an enlarged detail thereof;

FIG. 4 a further embodiment of a grinding and cleaning fleece according to the invention with circularly shaped burls in a top view;

FIG. 5 a further embodiment of a grinding and cleaning fleece according to the invention with circularly shaped burls in another arrangement in a top view;

FIG. 6 a further embodiment of a grinding and cleaning fleece according to the invention with circularly shaped burls in a top view;

FIG. 7 a further embodiment of a grinding and cleaning fleece according to the invention with square burls in a top view;

FIG. 8 a further embodiment of a grinding and cleaning fleece according to the invention with triangular burls in a top view;

FIG. 9 a further embodiment of a grinding and cleaning fleece according to the invention with triangular burls in a top view;

FIG. 10 a further embodiment of a grinding and cleaning fleece according to the invention with ellipse-shaped burls in a top view;

FIG. 11 a further embodiment of a grinding and cleaning fleece according to the invention with ellipse-shaped burls in a top view;

FIG. 12 a partial cross-sectional view of a schematically shown press for carrying out a method according to the invention for the manufacturing of a grinding and cleaning fleece before the pressing;

FIG. 13 the partial cross-sectional view of the press of FIG. 12 during the pressing;

FIG. 14 the partial cross-sectional view of the press of FIG. 12 after the pressing;

FIG. 15A: a schematic cross-sectional view of a further preferred embodiment of a grinding and cleaning fleece according to the invention;

FIG. 15B: a schematic cross-sectional view of a further preferred embodiment of a grinding and cleaning fleece according to the invention; and

FIG. 15C: a schematic cross-sectional view of a further preferred embodiment of a grinding and cleaning fleece according to the invention.

### DESCRIPTION OF PREFERRED EMBODIMENTS

In the following, preferred embodiments of the present invention are described by the use of the accompanying figures. Features of single embodiments can be combined with features of other embodiments, even if this is not explicitly shown or mentioned.

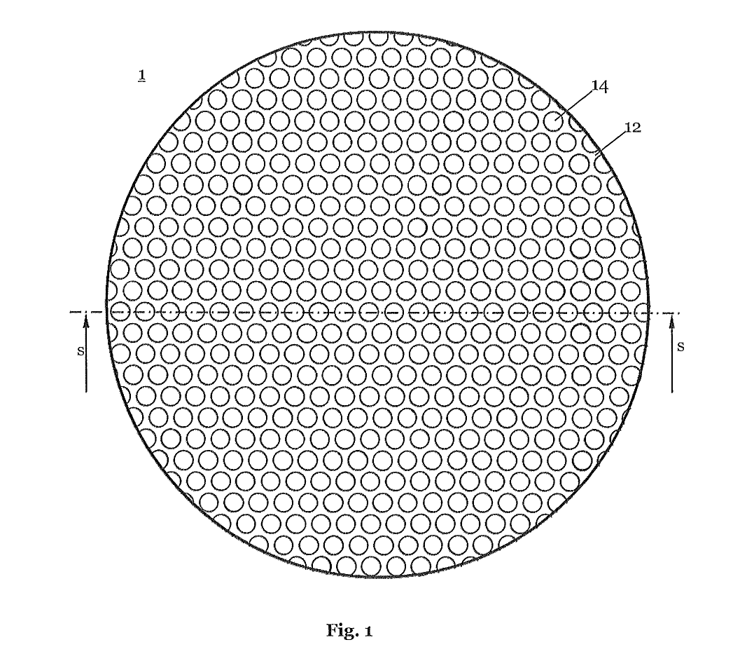

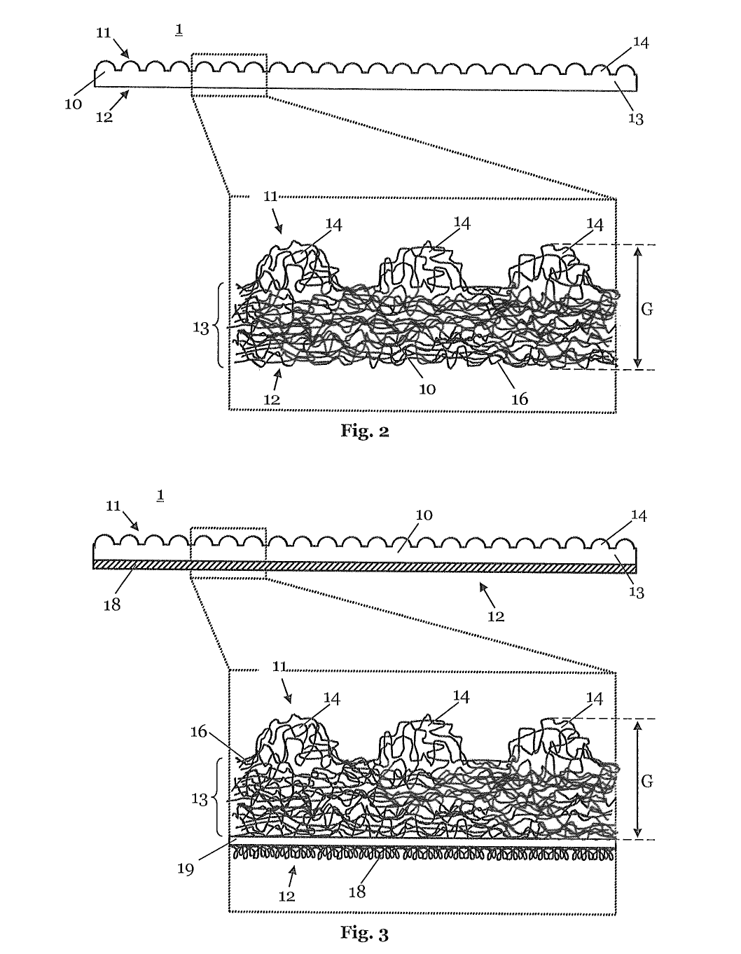

FIGS. 1 and 2 show a grinding and cleaning fleece 1 in a top view on the processing surface 11 and in a sectional view. The grinding and cleaning fleece 1 comprises a fleece body 10, which comprises a burled processing surface 11 and a plain fixation surface 12, which is opposed to the burled processing surface 11. The burled processing surface 11 consists of the surface of the burls 14 and the areas of the surface of base layer 13, which are arranged between the burls 14. The base layer 13 is the part of the fleece body 10, from which the plurality of burls 14 protrudes.

As shown in FIG. 1, the burls 14 are spread across the full surface of the base layer 13 in order to provide a processing of a surface to be processed, for instance of a structured polymer-flooring, as homogeneous as possible. Therefore, a disc floor cleaning machine is equipped with a grinding and cleaning fleece 1 in order to grind and/or to clean a structured flooring. However, a grinding and cleaning fleece 1 may be also used for other fields of application like for instance for the grinding or cleaning of other structured surfaces, like for instance walls by means of a hand-guided grinding and/or cleaning machine.

In the embodiment of FIG. 1, the burls 14 comprise a circular base, wherein the burls are shifted to each other in that the center points of three burls 14, which are adjacent to each other, from an equilateral triangle. Thus, a highest possible density of burls 14 per processing surface 11 is achieved, which is in particular advantageous for grinding and/or cleaning tasks in order to achieve a high abrasive performance.

The burled processing surface 11 is preferably impregnated with a binding resin, in particular a polyurethane- or latex-based binding resin or with an acryl-based dispersion in order to adhere abrasive particles, which increase the cleaning performance The abrasive particles can be for instance made of silicate or aluminum oxide or silicon carbide or zirconium or ceramics or diamond or mixtures thereof. Also other abrasive particles can be used. The grinding and cleaning fleeces 1 are adapted amongst others by the choice of the material of the abrasive particles and of the size of the abrasive particles to the specific grinding and/or cleaning task. For soft cleaning tasks, also grinding and cleaning fleeces 1 without abrasive particles are used.

The binding resin is preferably chosen such that it withstands aggressive cleaning agents, which are used for specific cleaning tasks. Thus, the life time of the grinding and cleaning fleece is increased. By the binding resin, the fleece body 10 itself also can be cured and stiffened, respectively so that the cleaning performance can be increased.

FIG. 2 shows the grinding and cleaning fleece 1 of FIG. 1 in a sectional view along the section line s-s and an enlarged detail thereof. In this enlarged detail of FIG. 2 it is shown that the fleece body 10 consists of a plurality of fibers 16, which are connected to each other in an irregular manner They comprise a fiber thickness of 1 dtex to 400 dtex, preferably of 27 dtex to 60 dtex. The fibers 16 are made of a polyester- or polyamide-based material, by which a high resistance in view of aggressive cleaning agents, like they are used for instance in hospitals, is ensured. For abrasive particles with a larger diameter, also a thicker fiber thickness is used.

The burls 14 are directly formed out of the base layer 13 in that some of the fibers, which build the base layer 13, protrude from the base layer 13 in order to form the burls 14. Herein, the burls 14 are an integral element of the fleece body 10 such that they are rigidly connected to the base layer 13 without having to use adhesives or the like. Furthermore, the shape increases the life time of the grinding and cleaning fleece 1.

The fleece body 10 comprises a total height G, which consists of the height of the base layer 13 and the height of the burls 14. The total height G is thus measured between the fixation surface 12 and the highest point of a burl 14.

The burls 14 comprise a density, which is reduced in view of the base layer 13, what leads to an increased resilience of the burls 14. Therefore, the burls 14 can enter into valleys of structured floorings in an easier manner in order to process the ground of the valley.

The plane fixation surface 12, which is shown in FIG. 2, is responsible for the direct connection of the grinding and cleaning fleece with a grinding and/or cleaning machine, like for instance with the brush plate of a disc floor cleaning machine. For this, the disc floor cleaning machine is merely put onto the grinding and cleaning fleece 1, which is lying on the floor. By gravity, a sufficient friction between the disc floor cleaning machine and the grinding and cleaning fleece 1 is generated, in order to drive the grinding and cleaning fleece 1 without slipping. This embodiment of the grinding and cleaning fleece 1 excels in its single-piece setup, i.e. the grinding and cleaning fleece 1 exclusively consists of the fleece body 10 on which—on demand—abrasive particles can be arranged by means of a binding resin.

FIG. 3 shows the grinding and cleaning fleece of FIG. 1 in another embodiment, wherein the grinding and cleaning fleece 1 comprises an additional hook-and-loop adaption layer 18 for the connection with a grinding and/or cleaning machine. The hook-and-loop adaption layer 18 is connected at the fixation surface 12 with the fleece body 10 by means of an adhesive layer 19. Preferably, the hook-and-loop layer 18 is a hook-and-loop velour or a hook-and-loop fleece layer, which can connect itself with a hook layer at the grinding and/or cleaning machine. The hook-and-loop system ensures a slip-free force transmission from the grinding and/or cleaning machine to the grinding and cleaning fleece 1, wherein here a gravity impact is not necessary.

The embodiment according to FIG. 3 is appropriate for use cases, wherein hand-guided grinding and/or cleaning machines are used, in order to carry out grinding and cleaning tasks not only on floors, but also on vertical walls, stairs or even “overhead”.

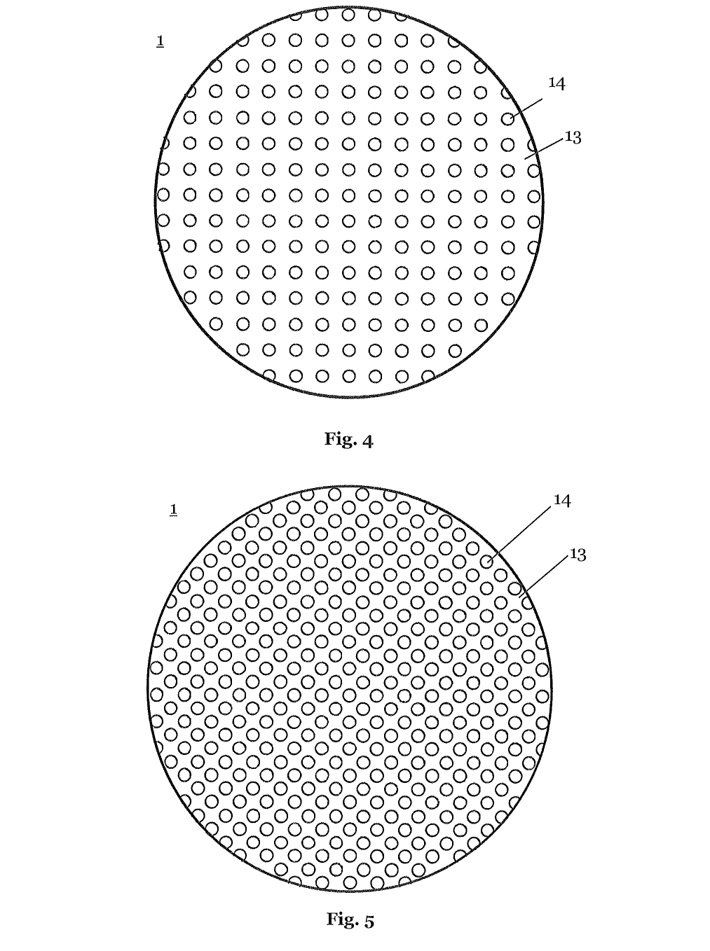

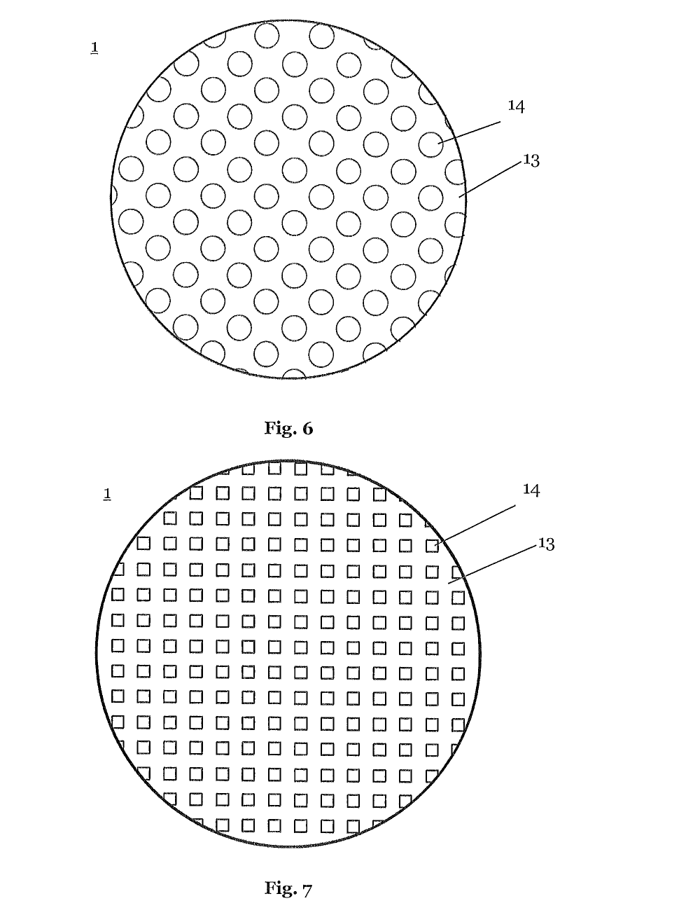

FIGS. 4 to 11 show different embodiments of the grinding and cleaning fleece 1, wherein burl-shapes, -sizes and -arrangements are varied in an exemplary manner The FIGS. 4 to 11 each show the processing surface 11 with the base layer 12 and the burls 14, wherein the burls 14 comprise depending on the figure another shape and/or another arrangement and/or another size. The burls 14 can comprise a base surface dimension and a burl height in the range of 3 mm to 20 mm.

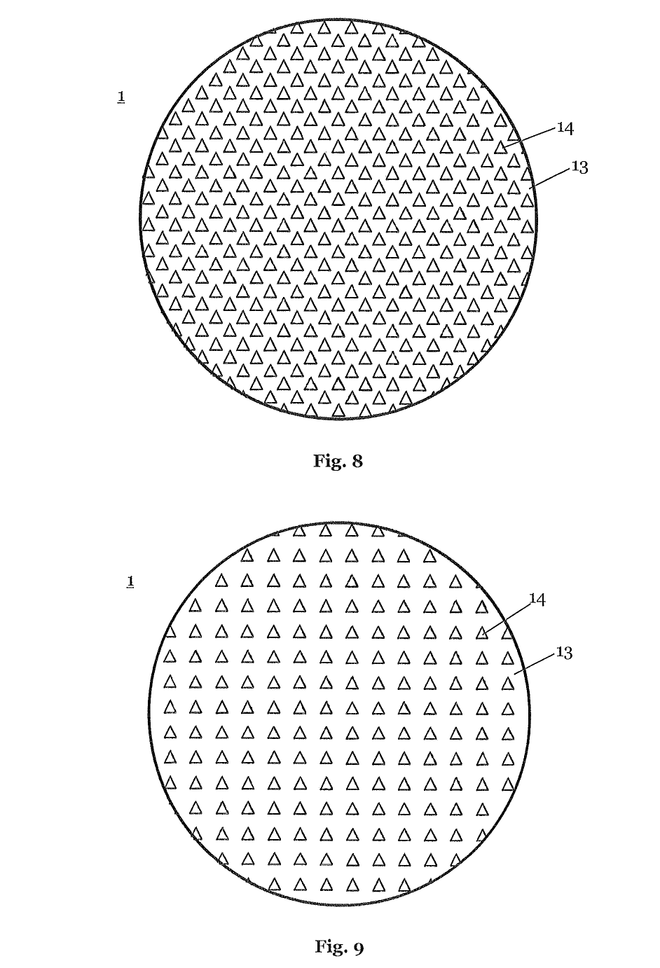

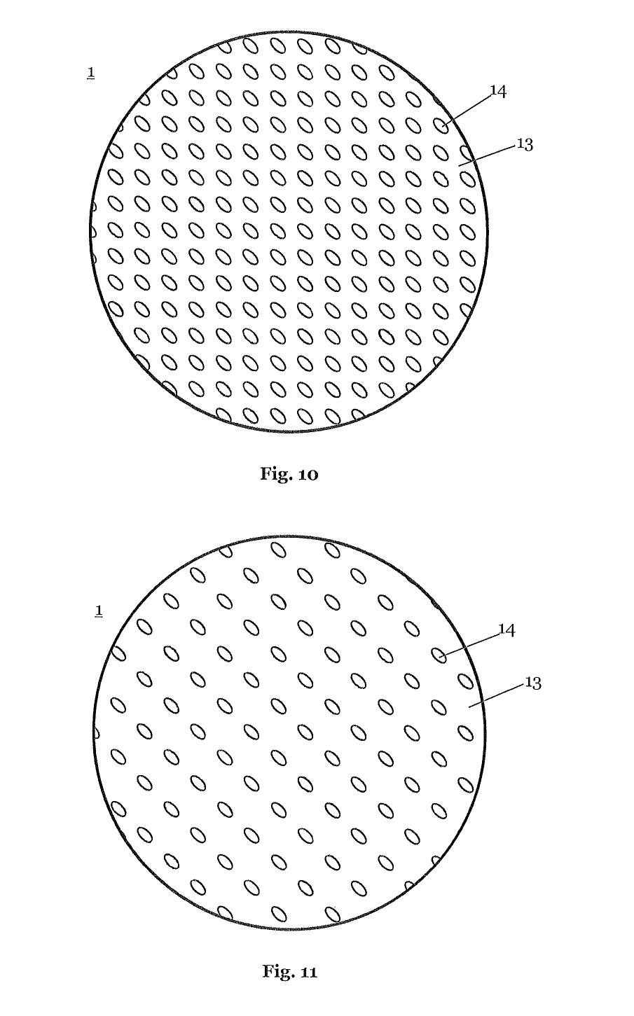

In the embodiments of the FIGS. 4, 5 and 6, the burls 14 are circular at their base; in FIG. 7 they are square; in the FIGS. 8 and 9 they are triangular and in FIGS. 10 and 11 ellipse-like. The selection of the base-shape of the burls 14 is done in view of the specific grinding and/or cleaning task in order to optimally adapt the grinding and cleaning fleece 1 to this task.

In the embodiments of the FIG. 1, three adjacent burls 14 are arranged shifted to each other in a manner that their center points form an equilateral triangle. In the embodiments of the FIGS. 4 to 11, the center points of 4 adjacent burls form the corner points of a square. By the different arrangements, the burl density on the processing surface 11 can be varied.

The plurality of burls 14 is preferably spread homogeneously over the entire processing surface 11. In particular cases, however, specific areas of the processing surface 11 can be left unburled in order to receive fixation means or suction openings.

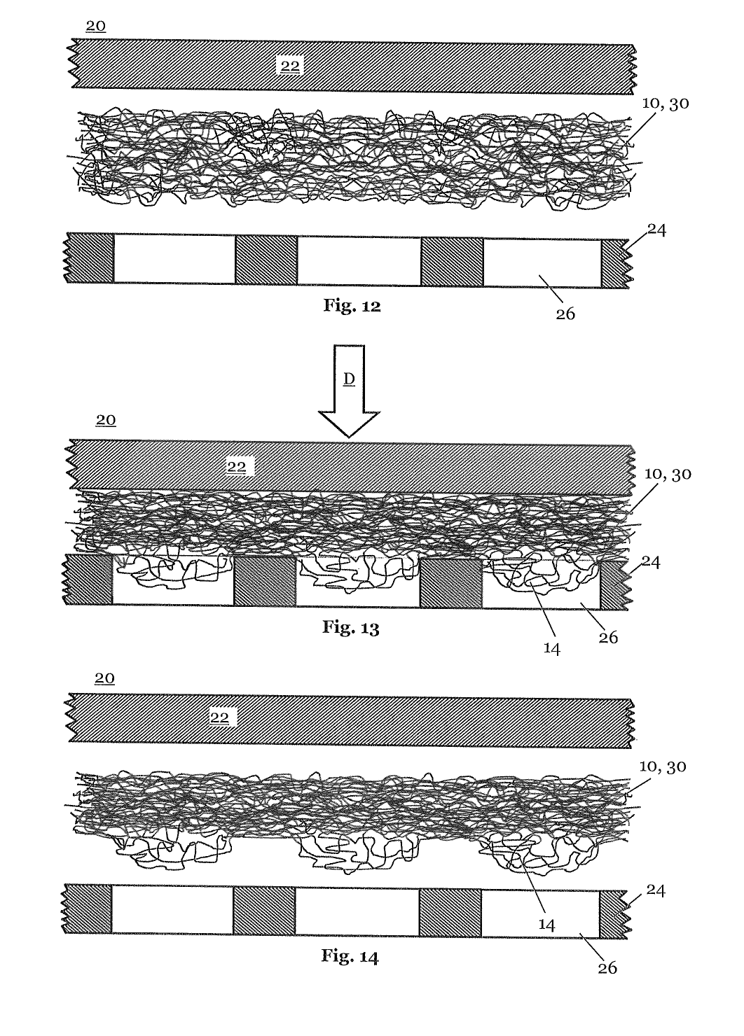

In the FIGS. 12 to 14, a method for the manufacturing of a grinding and cleaning fleece 1 is shown. The FIGS. 12 to 14 show a simplified principle sketch of a section of a press 20 in different phases during the manufacturing of a grinding and cleaning fleece 1.

FIG. 12 shows the press 20 during the inserting of a still plane fleece body 10 and a plane fleece web 30, respectively. In this phase, the fleece body 10 and the fleece web 30, respectively, still comprise two plane, parallel surfaces. The press 20 consists of a first plate 22, which is plane and continuous. A second plate, the counter plate 24 consists of a hole plate with openings 26. The openings 26 define the later base shape of the burls 14.

The plates 22, 24 of the press 20 preferably comprise a size of about 1 m×2 m and both plates 22, 24 can be heated, in order to heat the fleece body 10 and the fleece web 30, respectively, for an improved forming The temperatures, which are necessary for the subsequent forming are defined by the fleece material to be processed and are in a range between 80° C. and 200° C., preferably between 80° C. and 130° C. A flat press, which is able to generate pressure of 50 bar to 200 bar, is appropriate as press 20. A pressure of 130 bar has proven to be in particular appropriate.

The fleece body 10 differs from the fleece web 30 in that the fleece body 10 has been already cut to the size of the later grinding and cleaning fleece 1. If in the press 20 a fleece web 30 is processed, the step of cutting is carried out after the step of pressing. According to the size of the press 20, a fleece web 30 can comprise for instance a size of 1 m×2 m.

FIG. 13 shows the press 20 during the step of pressing. The plates 22, 24 are moved towards each other and loaded with pressure D of preferably 50 to 200 bar, in particular of 130 bar. Herein, the forming of the burls 14 takes place. During the step of pressing, the fleece body 10 and the fleece web 30, respectively, is heated and thus becomes plastically deformable. At the areas of the hole plate 24 where the fibers 16 are adjacent to an opening 26, the fibers 16 yields the pressure and form in the opening 26 the later burls 14. The pressure will be maintained for up to 5 minutes.

FIG. 14 shows the press 20 after the step of pressing. The load of the pressure is taken away and the plates 22, 24 are moved away from each other again such that the fleece body 10 and the fleece web 30, respectively, can now be removed and can cool down. The fleece body 10 and the fleece web 30, respectively, stays after the removal of the temperature- and pressure-load in the now generated form to a high extent so that the fleece body 10 and the fleece web 30, respectively, comprises a burled processing surface 11 after the pressing step.

Further processing steps may follow, in order to adapt the fleece body 10 and the fleece web 30, respectively, to the specific grinding and/or cleaning task. So, the fleece body 10 and the fleece web 30, respectively, can be for instance provided prior to or after the pressing with abrasive particles. Therefore, a binding resin, preferably a polyurethane- or latex-based binding resin can be applied onto the fleece body 10 and the fleece web 30, respectively For instance the binding resin can be sprayed. The abrasive particles are of silicate and/or aluminum oxide and/or carbide and/or zircon and/or ceramics and/or diamond or mixtures thereof. The abrasive particles are applied, wherein they sink in their entirety or in parts into the binding resin layer and are held after the curing of the binding resin by the binding resin at the processing surface 11 of the fleece body 10 and the fleece web 30, respectively.

Depending on the desired way of fixation of the grinding and cleaning body 1 at the grinding and/or cleaning machine, also a hook-and-loop adaption layer 18 may be attached to the fixation surface 12 of the fleece body 10 and the fleece web 30, respectively. Therefore, in a known manner an adhesive layer 19, which may be different from the above described binding resin, is applied onto the fixation surface 12 of the fleece body 10 and the fleece web 30, respectively. For instance it is sprayed. Then, a hook-and-loop adaption layer 18, preferably a hook-and-loop velour layer or a hook-and-loop fleece layer is applied, which sinks in parts into the adhesive layer 19 and after the curing of the adhesive layer 19, the adhesive layer 19 holds it at the fixation surface 12 of the fleece body 10 and the fleece web 30, respectively. Alternatively, a hook-and-loop adaption layer 18 with a melt-adhesive may be used. Since the curing of the adhesive layer 19 requires heat, the adhering of the hook-and-loop adaption layer 18 is carried out before the pressing of the fleece body 10.

If a fleece web 30 has been pressed, in a next step corresponding fleece bodies 10 are blanked or cut out of the fleece web 30 with known measures. In general, a plurality of fleece bodies 10 is cut or blanked out of a fleece web 30.

The method steps of the application of abrasive particles and the application of a hook-and-loop adaption layer are preferably carried out before the fleece body or the fleece web is pressed, so that after the pressing no further heat is necessary.

Machines, which are used for the machine-based grinding or cleaning are for instance portable grinding and/or cleaning machines (like for instance rotation grinders) or grinding and/or cleaning machines, which are pushed by a user in front of him/her (for instance single disc floor cleaning machines), or grinding and/or cleaning machines, wherein the user sits on them and drives around on them. These machines have in common that the grinding and cleaning fleece 1 is driven by a motor, usually by an electric motor in rotary or oscillatory movements.

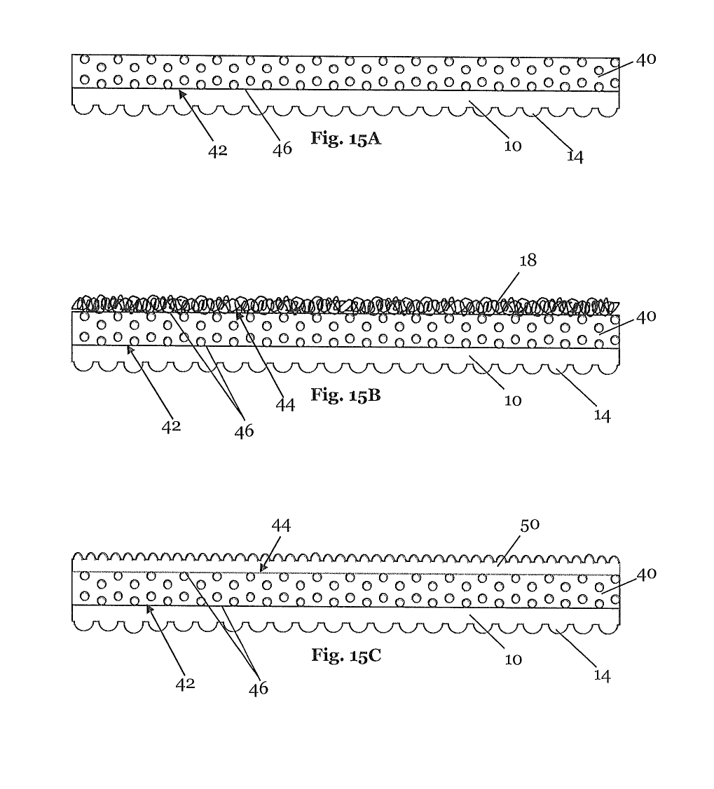

FIG. 15A shows a schematic cross-sectional view of a further preferred embodiment of a grinding and cleaning fleece 1 according to the invention, wherein the grinding and cleaning fleece 1 consists of the fleece body 10 and a foam body 40, wherein the foam body 40 is arranged at the fixation surface 12 of the fleece body 10.

The foam body 40 preferably consists of a polymer foam and can be adapted by a corresponding choice of the material, the foam density and the foam height to the grinding and/or cleaning tasks to be solved.

In the context of the choice of the material of the foam body 40, preferably a material is used, which resists aggressive cleaning agents without disintegration. Thus, the lifetime of the grinding and cleaning fleece is not limited by the foam body 40. Preferably, the foam body consists of a resilient plastic material foam, for example of a polyurethane foam, polyether foam or similar material.

The foam body preferably comprises a height of 3 mm to 30 mm, more preferred of 10 mm to 20 mm. Thus, it is ensured that the foam body 40 is on the one hand high enough in order to provide additional resilience for an adaption to unevenness of the surface to be treated and, on the other hand, the foam body 40 is not too high in order to provide still the necessary movement transmission from the grinding and/or cleaning machine to the grinding and cleaning fleece 1.

When grinding and cleaning fleeces 1 are used at a disc floor cleaning machine, they require a minimum height. But since during the generation of the burls 14 by means of the press 20 a loss of thickness of the fleece body 10 may appear, the minimum height is ensured by the foam body 40.

The foam body 40 is preferably also a depot for a specific amount of cleaning liquid, which is dispensed during the grinding and/or the cleaning from the depot.

The foam body 40 is preferably adhered by an adhesive layer 46 at a first side 42 of the foam body 40 to the fleece body 10.

FIG. 15B shows a schematic cross-sectional view of a further preferred embodiment of a grinding and cleaning fleece according to the invention, wherein the grinding and cleaning fleece 1 consists of the fleece body 10, the foam body 40 and the hook-and-loop adaption layer 18, wherein the foam body 40 is arranged at the fixation surface 12 of the fleece body 10 and the hook-and-look adaption layer is arranged at a surface of the foam body 40, which is the surface of the foam body 40 opposed to the surface at which the fleece body 10 is arranged.

The hook-and-loop adaption layer 18 is preferably adhered at the foam body 40 by means of an adhesive layer 46 at a second side 44 of the foam body 40. Preferably, adhesives are used for the adhesive layer 46, which are cold-curing. If warm-curing adhesives are used, the adhering preferably happens also before the burled processing surface 11 is generated in order to save the burls 14 from further heat introduction, which may support an accidental regression of the burls 14.

As already mentioned in the context of FIG. 3, the hook-and-loop layer 18 is a hook-and-loop velour or a hook-and-loop fleece layer, which can connect itself with a hook layer at the grinding and/or cleaning machine. The hook-and-loop system ensures a slip-free force transmission from the grinding and/or cleaning machine to the grinding and cleaning fleece 1, wherein here a gravity impact is not necessary. The embodiment according to FIG. 3 is appropriate for use cases, wherein hand-guided grinding and/or cleaning machines are used, in order to carry out grinding and cleaning tasks not only on floors, but also on vertical walls, stairs or even “overhead”.

FIG. 15C shows a schematic cross-sectional view of a further preferred embodiment of a grinding and cleaning fleece according to the invention, wherein the grinding and cleaning fleece 1 consists of the first fleece body 10, the foam body 40 and a second fleece body 50, wherein the foam body 40 is arranged at the fixation surface 12 of the fleece body 10 and the second fleece body 50 is arranged at a surface of the foam body 40, which is the surface of the foam body 40 opposed to the surface at which the fleece body 10 is arranged.

The second fleece body 50 is preferably adhered by means of an adhesive layer 46 at the second surface 44 to the foam body 40.

Preferably, adhesives are used for the above mentioned adhesive layers 46, which are cold-curing. If warm-curing adhesives are used, the adhering preferably happens also before the burled processing surface 11 is generated in order to save the burls 14 from further heat introduction, which may support an accidental regression of the burls 14.

In the shown embodiment, the second fleece body 50 comprises a cleaning ability, which differs from the cleaning ability of the first fleece body 10, as it is indicated by the different burl profile in FIG. 15C.

The different cleaning abilities of the two fleece bodies 10, 50 is determined by different fiber materials and/or different fiber thicknesses and/or different fiber densities and/or different fleece body total heights G and/or different abrasive particle materials and/or different abrasive particle sizes and/or different abrasive particle amounts on the two processing surfaces of the fleece bodies and/or different burl geometries and/or different burl heights and/or different burl arrangements.

### LIST OF REFERENCE SIGNS

1 grinding and cleaning fleece
10 fleece body
11 processing surface
12 fixation surface
13 base layer
14 burls
16 fibers
18 hook-and-loop adaption layer
19 adhesive layer
20 press
22 first plate of the press
24 counter plate/hole plate
26 opening
30 fleece web
40 foam body
42 first surface of the foam body
44 second surface of the foam body
46 adhesive layer
50 second fleece body
D pressure
G total height

What is claimed is:

1. Grinding- and cleaning-fleece (1) for the machine-based grinding and machine-based cleaning of structured surfaces, comprising a fleece body (10), which comprises a processing surface (11) with a plurality of burls (14).

2. Grinding- and cleaning-fleece according to claim 1, wherein the burls (14) of the burled processing surface (11) are integral elements of the fleece body (10).

3. Grinding- and cleaning-fleece according to claim 2, wherein the burls (14) of the processing surface (11) comprise a lower density than the other areas of the fleece body (10).

4. Grinding- and cleaning-fleece according to claim 1, wherein the fleece body (10) furthermore comprises a plane fixation surface (12), which is opposed to the processing surface (11).

5. Grinding- and cleaning-fleece according to claim 4, wherein the grinding- and cleaning-fleece (1) consists of a configuration chosen from the group consisting of:
a. solely of the fleece body (10); and
b. the fleece body (10) together with a hook-and-loop adaption layer (18), wherein the hook-and-loop adaption layer (18) is arranged at the fixation surface (12) of the fleece body (10); and
c. the fleece body (10) together with and a foam body (40), wherein the foam body (40) is arranged at the fixation surface (12) of the fleece body (10); and
d. the fleece body (10) together with a foam body (40) and a hook-and-loop adaption layer (18), wherein the foam body (40) is arranged at the fixation surface (12) of the fleece body (10) and wherein the hook-and-loop adaption layer (18) is arranged at a surface of the foam body (40), which is opposed to the surface of the foam body (40), at which the fleece body (10) is arranged; and
e. the fleece body (10) together with a foam body (40) and a second fleece body (50), wherein the foam body (40) is arranged at the fixation surface (12) of the fleece body (10) and wherein the second fleece body (50) is arranged at a surface of the foam body (40), which is opposed to the surface of the foam body (40), at which the fleece body (10) is arranged.

6. Grinding- and cleaning-fleece according to claim 5, wherein the second foam body (50) comprises a cleaning ability, which differs from the cleaning ability of the fleece body (10), if the grinding- and cleaning-fleece consists of the fleece body (10), the foam body (40) and the second fleece body (50).

7. Grinding- and cleaning-fleece according to claim 2, wherein the fleece body (10) of the grinding- and cleaning-fleece (1) comprises abrasive particles, which are attached to the processing surface (11) of the grinding- and cleaning-fleece (1) by means of a binding resin.

8. Grinding- and cleaning-fleece according to claim 2, wherein the burls (14) comprise a height of 25% to 75%, preferably of 40% to 60% and most preferably of 50% of the total height (G) of the fleece body (10), wherein the total height (G) is measured from the fixation surface (12) of the fleece body (10) to the highest point of a burl (14).

9. Grinding- and cleaning-fleece according to claim 2, wherein the burls (14) comprise at their base a maximum width of 3 mm to 30 mm, preferably a maximum width of 10 mm to 15 mm.

10. Grinding- and cleaning-fleece according to claim 2, wherein the burls (14) comprise as base shapes circles and/or polygons and/or ellipse-like geometries.

11. Grinding- and cleaning-fleece according to claim 2, wherein the fleece body (10) comprises a grammage of 120 g/m² to 2.000 g/m², preferably a grammage of 500 g/m² to 1.600 g/m².

12. Grinding- and cleaning-fleece according to claim 1, wherein the grinding- and cleaning-fleece (1) consists of polyester- or polyamide-based fibers, which comprise a thickness of 1 to 400 dtex, preferably of 27 to 60 dtex.

13. Grinding- and cleaning-fleece according to claim 2, wherein the fleece body (10) comprises a total height (G) of 4 mm to 30 mm, preferably a total height (G) of 8 mm to 20 mm and more preferably a total height (G) of 10 mm to 15 mm.

14. Grinding- and cleaning-fleece according to claim 2, wherein the fleece body (10) comprises a round disc-shape with a diameter of 200 mm to 800 mm or a rectangular cut with a width of 115 mm-230 mm and a length of 200 mm-500 mm.

15. Method for the manufacturing of a grinding- and cleaning-fleece (1) for the machine-based grinding and machine-based cleaning of structured surfaces, comprising a burled processing surface (11), wherein the method comprises the following steps:
a. inserting of a layer comprising a fleece web (30) or a fleece body (10) into a press (20), wherein a first plate (22) of the press (20) is plane and wherein a counter plate (24) of the press (20) comprises a perforated metal plate;
b. moving of the plates (22, 24) of the press towards each other with a pressure (D) of 50 bar to 200 bar and a temperature of 50° C. to 200° C.;
c. maintaining of the pressure (D); and
d. removing of the body, which comprises a burled processing surface (11).

16. Method for the manufacturing of a grinding- and cleaning-fleece according to claim 15, wherein the layer comprises a fleece web (30) the method further comprising the step of:
e. separating of a fleece body (10) out of the fleece web (30).

17. Method for the manufacturing of a grinding- and cleaning-fleece according to claim 15, furthermore comprising the steps:
f. applying a binding resin onto the layer consisting of the fleece body (10) or onto the fleece web (30), prior to the inserting of the layer into the press (20); and
(g) applying abrasive particles onto the binding resin.

18. Method of using a grinding- and cleaning-fleece (1) according to claim 2 for the machine-based grinding and machine-based cleaning of structured floorings with a disc floor cleaning machine.

19. The method of claim 18, wherein the grinding- and cleaning-fleece (1) is connected with the disc floor cleaning machine by a method chosen from the group consisting of:
a. putting the disc floor cleaning machine onto the grinding- and cleaning-fleece (1) with no additional steps; and
b. attaching the grinding- and cleaning-fleece (1) at the disc floor cleaning machine by means of a hook-and-loop adaption layer (18).
